(19) United States
(12) Patent Application Publication
(10) Pub. No.: US 2015/0078015 A1
(43) Pub. Date: Mar. 19, 2015

(54) ANTI-THEFT COLLAR FOR A LIGHT BULB

(71) Applicant: Switch Bulb Company, Inc., San Jose, CA (US)

(72) Inventors: Andrew WEBB, San Jose, CA (US); Roget RATCHFORD, Menlo Park, CA (US); Vanvisa ATTASET, San Francisco, CA (US)

(73) Assignee: SWITCH BULB COMPANY, INC., San Jose, CA (US)

(21) Appl. No.: 14/029,723

(22) Filed: Sep. 17, 2013

(51) Int. Cl. F21V 15/00

(52) U.S. Cl. CPC F21V 15/005
USPC 362/377

(57) ABSTRACT

An anti-theft system for preventing removal of a light bulb when installed in a socket housing of a light fixture. The anti-theft system includes an anti-theft collar configured to mechanically engage with the light bulb and the socket housing. The anti-theft collar includes a wall portion configured to enclose at least a portion of the light bulb and at least a portion of the socket housing. The anti-theft collar also includes one or more features configured to inhibit rotation of the light bulb with respect to the anti-theft collar when the anti-theft collar is installed. The anti-theft collar also includes one or more features configured to inhibit movement of the anti-theft collar with respect to the socket housing of the light fixture.

### BACKGROUND

1. Field

The present disclosure relates generally to an anti-theft system for a light bulb, and more specifically to an anti-theft collar that prevents a light bulb from being removed from a light fixture.

2. Description of Related Art

Recently, a variety of alternatives to the incandescent bulb have emerged in the marketplace. For example, light-emitting diode (LED) bulbs and compact fluorescent bulbs have become increasingly available to meet an increasing demand for energy efficient alternatives to standard incandescent bulbs. LED bulbs have emerged as one energy-efficient, long-lasting alternative to incandescent light bulbs. One example of an LED bulb that can be used with standard light-bulb sockets is provided in U.S. Pub. No. US2013/0010480, which is incorporated by reference herein in its entirety.

An LED bulb may use less power, last longer, and cost less to operate as compared to incandescent alternatives. However, some LED bulbs may have a higher initial purchase price, and therefore require more of an initial investment. In addition to their functional advantages, LED bulbs may also be perceived as novel and aesthetically pleasing. Other types of (non-LED) bulbs may also cost more money and offer features not commonly available in traditional incandescent bulbs. Factors such as cost, durability, and visual appeal may lead to a greater risk of theft for some alternative light bulbs as compared to traditional incandescent light bulbs, which are relatively inexpensive and ubiquitous. The risk of theft may be particularly high for light bulbs that are installed in hotels, offices, or public areas that have minimal supervision.

Most traditional light-bulb fixtures are not designed to prevent theft of an installed light bulb. In fact, many traditional light-bulb fixtures include an Edison screw socket or bayonet mount that are designed for ease of light bulb installation and removal. Accordingly, there is a need for a device that can deter or prevent removal of a light bulb from the socket of a light fixture.

### BRIEF SUMMARY

One exemplary embodiment is directed to an anti-theft system for preventing removal of a light bulb when installed in a socket housing of a light fixture. The anti-theft system includes a ring having a protrusion, wherein the ring is attached, or configured to be attached, to the light bulb. The anti-theft system also includes a collar configured to mechanically engage with the ring and the socket housing. The collar includes a wall portion that is configured to enclose at least a portion of the light bulb and at least a portion of the socket housing. The collar also includes a cavity portion that is formed within the wall portion. The cavity portion is configured to engage the protrusion of the light bulb to inhibit rotation of the light bulb with respect to the collar when the collar is installed. The collar also includes a lower portion that extends from one end of the wall portion. The lower portion has an upper surface that is configured to engage with an opposing lower surface of the socket housing to inhibit motion of the collar in a direction along a central axis of the light bulb. In some embodiments, the protrusion formed as part of the light bulb.

In some embodiments, an opening is formed in the wall portion. The opening is configured to at least partially encircle a key of the light fixture when the collar is installed to inhibit rotation of the collar with respect to the light fixture by mechanically engaging with the key.

In some embodiments, the cavity portion is formed from an opening in the wall portion of the collar. In other embodiments, the cavity portion is formed from a blind recess in the wall portion of the collar. For example, the cavity portion may not form a hole or opening in the wall portion of the collar.

In some embodiments, the collar is formed from two pieces that are configured to be mechanically joined by one or more mechanical interlocks. The two pieces may or may not be symmetric or identical to each other. In some embodiments, each mechanical interlock includes at least one tab portion on a first of the two pieces, and at least one slot portion on a second of the two pieces. The tab portion and the slot portion are configured to interlock with each other. In some cases, the tab portion includes a beveled leading edge to facilitate installation and the tab portion includes a catch barb to inhibit removal of the collar after installation. In some cases, the collar is formed from more than two pieces.

The light bulb may be an LED bulb. The light bulb may also be a non-LED bulb, including, for example, a compact florescent or incandescent light bulb. In some embodiments, the light bulb includes a base having a threaded portion for insertion into the socket housing. In this case, the protrusion is formed as part of a ring that is attached to the base of the light bulb above the threaded portion. In some cases, the ring is mechanically integrated with the base of the light bulb. In other cases, the ring is configured for installation on the base of the light bulb after the light bulb has been manufactured.

Another exemplary embodiment is directed to an anti-theft system for preventing removal of a light bulb when installed in a socket housing of a light fixture. The anti-theft system includes a ring having a protrusion, wherein the ring is attached to the light bulb. The anti-theft system also includes a collar configured to mechanically engage with the ring and the socket housing. The collar includes a wall portion that is configured to enclose a portion of the light bulb and a portion of the socket housing. The collar also includes a cavity portion formed within the wall portion. The cavity portion is configured to engage the protrusion of the light bulb to inhibit rotation of the light bulb with respect to the collar when the collar is installed. The collar also includes an opening formed in the wall portion. The opening is configured to at least partially encircle a key of the light fixture when the collar is installed to inhibit rotation of the collar with respect to the light fixture by mechanically engaging with the key. The cavity portion may be formed from an opening in the wall portion of the collar or may be formed from a blind recess in the wall portion. In some embodiments, the protrusion formed as part of the light bulb.

### DESCRIPTION OF THE FIGURES

FIG. 1 depicts an exemplary anti-theft collar used to secure an LED bulb in a light fixture.

FIG. 2 depicts an exemplary LED light bulb having a ring and protrusions.

FIG. 3 depicts a cross-sectional view of an exemplary collar installed around an LED bulb having a ring with two protrusions.

FIG. 4 depicts one piece of an exemplary collar installed around a socket fixture and an LED bulb.

FIG. 5 depicts an exemplary anti-theft collar used to secure an LED bulb to a light fixture.

FIG. 6 depicts an exemplary LED light bulb having protrusions.

FIG. 7 depicts a cross-sectional view of an exemplary collar, an LED bulb, and a light fixture.

FIGS. 8A-B depict two pieces of an exemplary collar.

FIG. 9A depicts a top view of one piece of an exemplary collar.

FIG. 9B depicts a top view of one piece of an exemplary collar.

FIG. 9C depicts a top view of two pieces of an exemplary collar coupled by a mechanical interlock.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The following description is provided with respect to an LED bulb. However, a person of ordinary skill in the art would understand that the examples can also be applied to other types of light bulbs that are not LED bulbs. For example, the anti-theft system and anti-theft collar described below can be used to secure a compact florescent, traditional incandescent, or other type of light bulb.

### 1. Anti-Theft System Including an Anti-Theft Collar

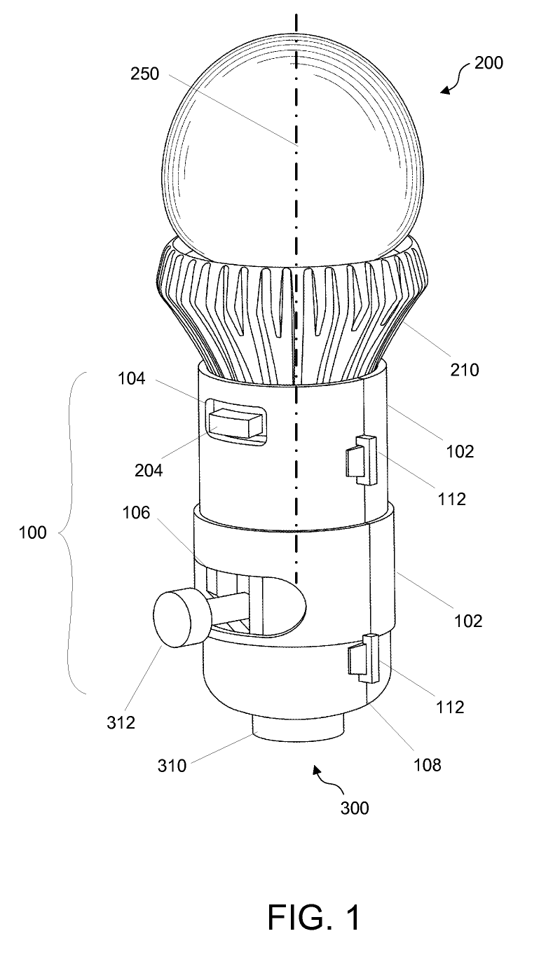

FIG. 1 depicts exemplary (anti-theft) collar 100 used to secure an LED bulb 200 to a light fixture 300. In general, the collar 100 is configured to deter removal of the LED bulb 200 from the light fixture 300 by impeding relative motion between the LED bulb 200 and the light fixture 300. In this example, the collar 100 is configured to mechanically engage with one or more features of the LED bulb 200 and a portion of a socket housing 310 of the light fixture 300 to prevent the rotation of the LED bulb 200 with respect to the socket housing 310.

As shown in FIG. 1, the collar 100 includes a wall portion 102 that is configured to partially enclose the LED bulb 200 and the socket housing 310 of the light fixture 300. In this example, the wall portion 102 encircles a portion of the base 210 of the LED bulb 200 and a portion of the socket housing 310. As shown in FIG. 1, the wall portion 102 is formed from two semi-cylindrical-shaped pieces that are joined by a mechanical interlock 112.

As shown in FIG. 1, the collar 100 includes a cavity portion 104 within the wall portion 102. In general, the cavity portion 104 includes a recessed feature that forms a recessed depression or hole in the wall portion 102 of the collar 100. In this example, the cavity portion 104 extends completely through the wall portion 102 forming a hole in the wall portion 102. The cavity portion 104 is configured to mechanically engage a protrusion 204 that is attached to or otherwise fixed with respect to the bulb 200. In this example, the protrusion 204 extends into the cavity portion 104 and through the wall section 102, preventing the rotation of the bulb 200 with respect to the collar 100.

The collar 100 also includes an opening 106 formed in the wall portion 102. In general, the opening 106 includes a void or hole in the wall portion 102 of the collar 100. As shown in FIG. 1, a key 312 of the light fixture 300 protrudes through the opening 106 when the collar 100 is installed. In this example, the key 312 is a turn knob that is used to control the power and/or power level supplied to the LED bulb 200. In other examples, the key 312 may include a push/pull-type switch for controlling the power to the LED bulb 200. The opening 106 in the wall portion 102 serves two purposes. First, the opening 106 permits external access to the key 312. Second, the opening 106 is configured to mechanically engage with the key 312 to prevent rotation of the collar 100 with respect to the socket housing 310 of the lighting fixture 300.

In this example, the opening 106 is configured to encircle the key 312 when the collar 100 is installed on the light fixture 300. The opening 106 is substantially oval-shaped and is at least as large as the largest portion of the key 312, which facilitates installation of the collar 100 without having to remove the key 312 or deform the collar 100. However, in other embodiments, the opening 106 may only partially encircle the key 312 and have a size that is slightly larger than a shaft portion of the key 312. For example, the opening 106 may be formed from a u-shaped channel in the wall portion 102 of the collar 100 that is configured to slide around the key 312 during installation. The size, shape, and location of the opening 106 may vary depending on the configuration of key 312 and socket housing 310.

In some embodiments, the collar 100 may not have a lower opening, if, for example, the collar is used on a light fixture that does not have a key 312. In this case, the key cannot be used to prevent the collar 100 from rotating with respect to the light fixture 300. However, for cases where the light fixture does not include a key 312, the collar 100 may include one or more additional features that prevent the LED bulb 200 from being removed from the light fixture 300.

For example, as shown in FIG. 1, the collar 100 also includes a lower portion 108 extending from one end of the wall portion 102. The lower portion 108 is configured to prevent the LED bulb 200 and collar 100 from being removed from the lighting fixture 300. Specifically, the lower portion 108 prevents the collar 100 and the LED bulb 200 from being pulled completely out of the socket housing 310. In this example, the lower portion 108 is formed from a portion of both pieces of the collar 100 that extend from the bottom edge of the wall portion 102 to form an inverted dome-shaped structure. The lower portion 108 is configured to curve around the bottom of the socket housing 310 of the light fixture 300 when installed. In this example, the lower portion 108 also forms a hole or opening for the passage of wires and/or the post used to connect the socket housing 310 with other parts of the lamp or appliance. In this example, the wall portion 102 and lower portion 108 together completely enclose the socket housing 310. In an alternative embodiment, the lower portion may be formed from another shape. For example, the lower portion may extend from one end of the wall portion at a 90 degree angle from the wall portion to form a flat-bottomed lower portion. The lower portion may also be formed from one or more finger-like protrusions configured to inhibit motion of the collar 100 along the central axis 250 of the LED bulb 200.

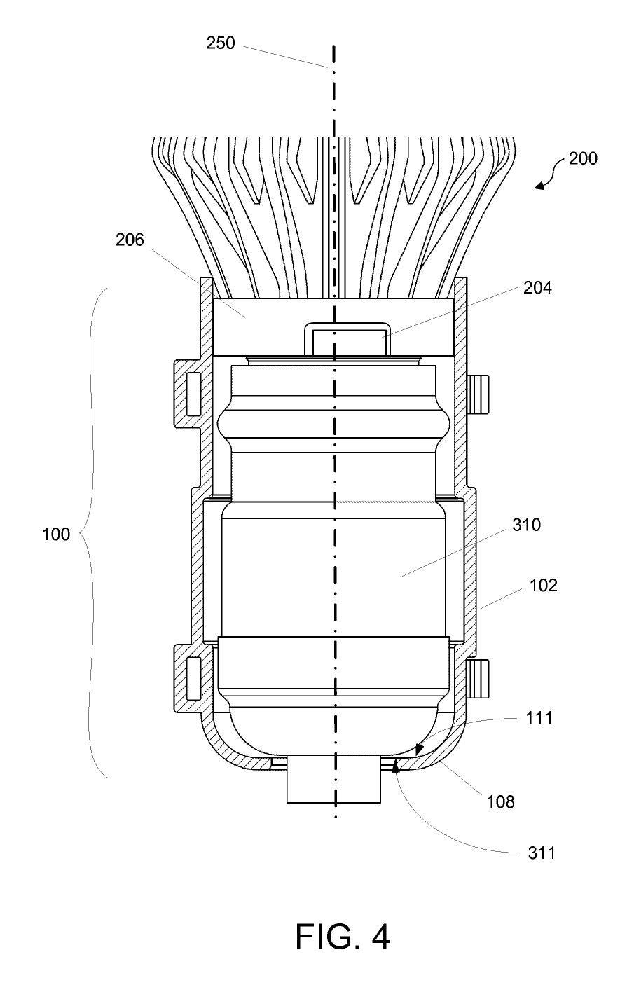

In the example depicted in FIGS. 1 and 4, the lower portion 108 is configured to engage with the socket housing to inhibit motion of the collar 100 with respect to the socket housing 310 in a direction along a central axis 250 of the LED bulb. This prevents the collar 100 and LED bulb 200 (which are mechanically engaged by the protrusion 204 and cavity 104) from being removed from the lighting fixture 300 by unscrewing the LED bulb 200. A more detailed description of the lower portion 108 is provided below with respect to FIG. 4.

As discussed in more detail with respect to FIGS. 10A-B and 11A-C, collar 100 is formed from two pieces that are configured to be mechanically joined during installation. As shown in FIG. 1, collar 100 includes multiple mechanical interlocks 112 that join the two pieces together when installed on the lighting fixture. In this example, the mechanical interlocks 112 are also configured to inhibit disassembly and removal from the LED bulb 200 and light fixture 300 to deter theft of the LED bulb 200. Specifically, the mechanical interlocks 112 include a tapered catch-barb tab portion that facilitates installation and inhibits removal without a specialized tool.

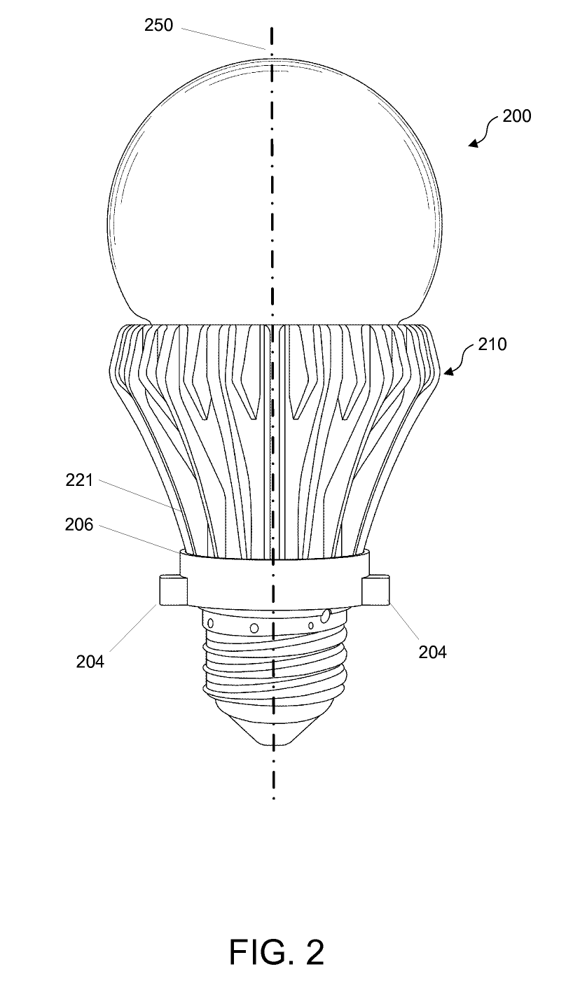

FIG. 2 depicts an exemplary LED bulb 200 having a ring 206 with two protrusions 204. As described above with respect to FIG. 1, each protrusion 204 is configured to engage with a corresponding cavity portion 104 of the collar 100 to prevent rotation of the LED bulb 200 with respect to the collar 100. Each protrusion 204 may also engage with the cavity portion to also prevent relative motion between the collar 100 and the LED bulb 200 in a direction along a central axis 250 of the LED bulb 200. In some cases, the protrusions 204 may also be referred to as protuberances or nubs.

In this example, each protrusion 204 is formed from a rectangular protrusion extending outward radially from the base 210 of the LED bulb 200. As shown in FIG. 2, the protrusions 204 are formed as part of a ring 206 that is attached to the base 210 of the LED bulb 200. In this case, the ring 206 mechanically engages with one or more cooling fins 221 to prevent rotation of the ring 206 with respect to the base 210 of the LED bulb 200. The ring 206 may also be bonded to the base 210 using an adhesive or other mechanical bonding technique. In some embodiments, only one protrusion 204 may be formed as part of the ring 206. Alternatively, there may be more than two protrusions 204 formed as part of the ring 206.

In this example, the ring 206 having protrusions 204 may be installed on the base 210 during the manufacturing process. The ring 206 may also be installed after manufacture by a purchaser or end-user of the LED bulb 200. A customer-installed alternative may be advantageous by allowing the manufacture to produce one type of LED bulb that can be used for locking and non-locking applications. In this case, the ring 206 can be installed on the LED bulb 200 by the purchaser, end-user, or other person, and convert a non-locking LED bulb to a locking LED bulb, as needed.

In alternative examples that do not include and LED bulb or do not include an LED bulb having cooling fins, the ring 206 may be attached to the base using another feature of the light bulb. For example, the ring may mechanically engage with ridge or groove in the base of the light bulb to prevent the rotation of the ring with respect to the light bulb. In some cases, there is no feature to prevent the rotation of the ring with respect to the light bulb and the ring is attached to the light bulb by an adhesive or other bonding technique.

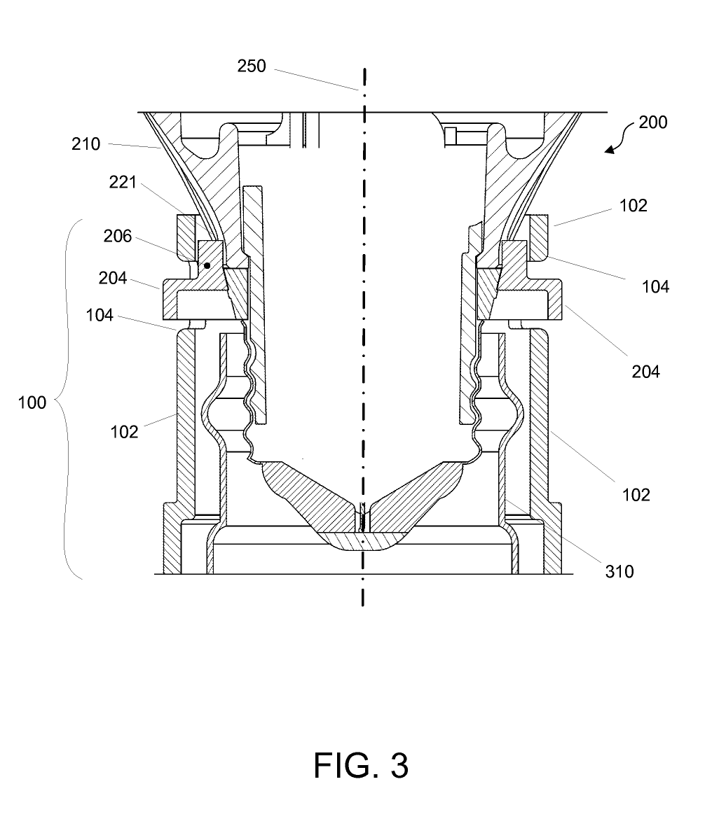

FIG. 3 depicts a cross-sectional view of a collar 100 used to secure an LED bulb 200 with protrusions 204 to a socket housing 310 of a lighting fixture. As shown in FIG. 3, the protrusions 204 are formed as part of ring 206, which is attached to the base 210 of the LED bulb 200. The ring 206 includes multiple grooves that are configured to mechanically engage with the fins 221 of the base 210. The mechanical engagement of the grooves in the ring 206 and the fins 221 of the base 210 prevent the ring 206 from rotating with respect to the LED bulb 200. As mentioned above, in applications where a finned LED bulb is not used, the light bulb may include other features to mechanically engage the ring. In some cases, there is no feature to mechanically engage the ring to prevent rotation and the ring is attached to the light bulb by an adhesive or other bonding technique.

As shown in FIG. 3, the protrusions 204 are formed from two rectangular protrusions that extend radially from the central axis 250 of the LED bulb and mechanically engage corresponding cavity portions 204 formed in the wall portion 102 of the collar 100. In this example, the protrusions 204 extend completely through the wall portion 102. The mechanical engagement between the protrusions 204 and the cavity portions 204 prevents the LED bulb 200 from rotating with respect to the collar 100.

As shown in FIG. 3, the wall portion 102 of the collar 100 is larger than the socket housing 310 to provide a gap between the socket housing 310 and the collar 100 when installed. Typically, the gap is sufficiently large to allow for minor variations in the size and shape of the socket housing 310 to avoid a mechanical interference between the collar 100 and the socket housing 310. The gap is also smaller than the overlap between the protrusion 204 and the cavity portion 104 in a direction perpendicular to the central axis 250 of the LED bulb 200 to ensure that the protrusion 204 and cavity portion 104 remain mechanically engaged.

FIG. 4 depicts one piece of an exemplary collar installed around a socket fixture 310 and LED bulb 200. The view shown in FIG. 4 is at approximately 90 degrees with respect to the cross-section view depicted in FIG. 3. As shown in FIG. 4, the collar 100 includes a lower portion 108 that extends from one end of the wall portion 102 to form an inverted dome-shaped structure that encloses the lower portion of the socket housing 310. The lower portion 108 includes an upper surface 111 that is configured to engage with an opposing lower surface 311 of the socket housing 310 to inhibit motion of the collar in a direction along a central axis of the LED bulb 250. The engagement between the upper surface 111 of the lower portion 108 and the opposing lower surface 311 of the socket housing 310 prevents the LED bulb 200 and the collar 100 from being removed from the lighting fixture. In this example, the LED bulb 200 is prevented from becoming completely unscrewed from the socket housing 310 because the upper surface 111 of the lower portion 108 comes in contact with the lower surface 311 of the socket housing 310 preventing the removal of the LED bulb 200 from the socket housing 310.

As shown in FIG. 4, the lower portion 108 also forms a hole or opening to allow the socket housing 310 to be attached to the rest of the lighting fixture. The hole or opening also allows for wires or other electrical connections to be routed to the socket housing 310.

In an alternative embodiment, the lower portion may not be a fully revolved dome-shaped structure. For example, the lower portion may be formed from two or more finger-shaped structures that extend from the bottom end of the wall structure 102 towards the central axis 250. In this case, each finger-shaped structure includes an upper surface that is configured to engage with the lower surface of the socket housing to inhibit motion of the collar in a direction along the central axis 250.

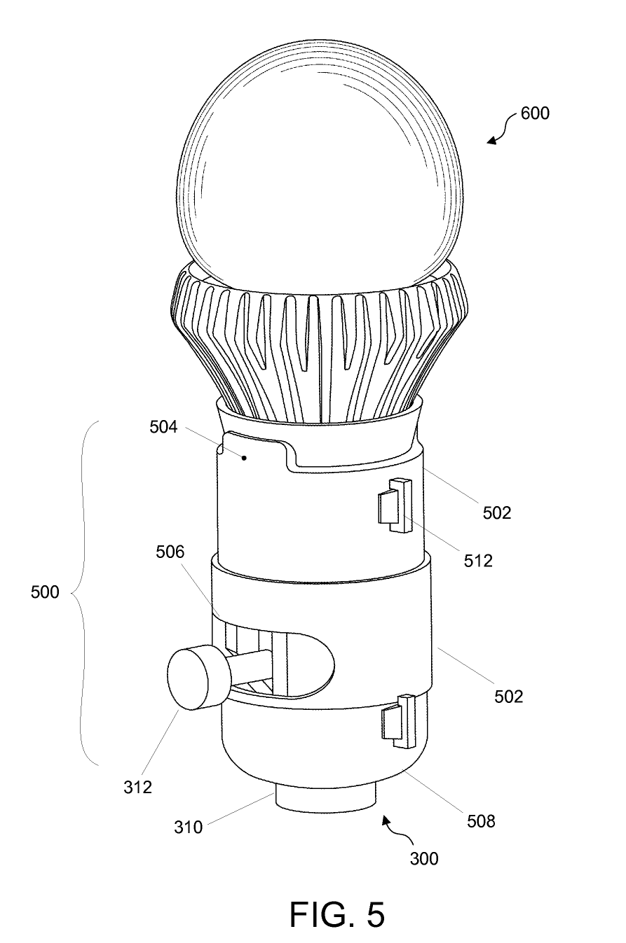

FIG. 5 depicts another exemplary (anti-theft) collar 500 used to secure an LED bulb 600 to a light fixture 300. Similar to the collar 100 of FIG. 1, the collar 500 of FIG. 5 is configured to mechanically engage with one or more features of the LED bulb 600 and a portion of a socket housing 310 of the light fixture 300 to prevent the rotation of the LED bulb 600 within the socket housing 310.

As shown in FIG. 5, the collar 500 includes a wall portion 502 that is configured to partially enclose the LED bulb 600 and the socket housing 310 of the light fixture 300. In this example, the wall portion 502 is formed from two semi-cylindrical-shaped pieces that are joined by multiple mechanical interlocks 512.

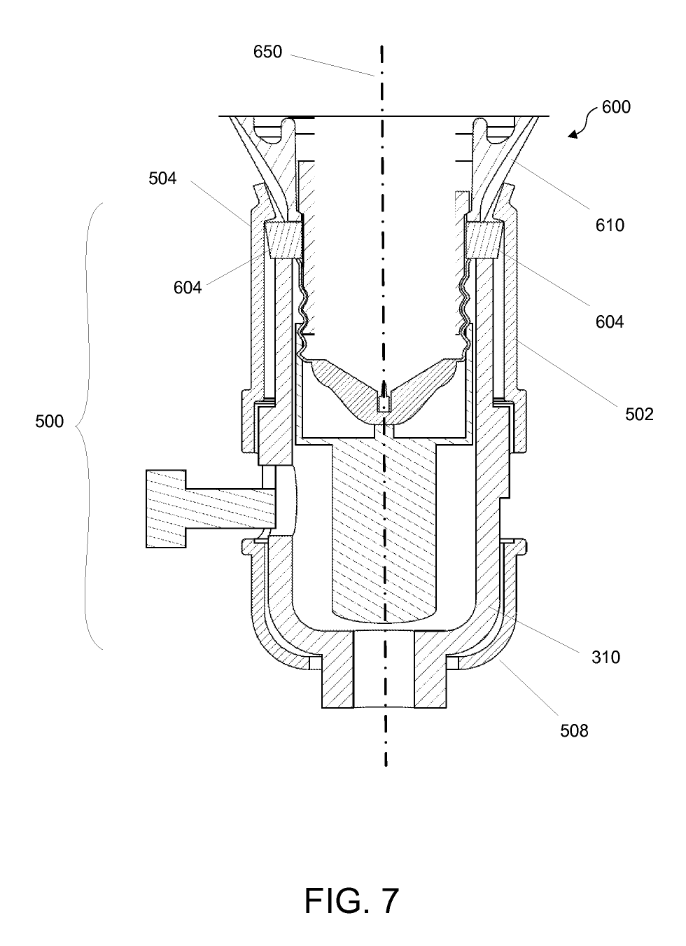

As shown in FIGS. 5 and 7, the collar 500 also includes a cavity portion 504 within the wall portion 502. In this example, the cavity portion 504 forms a blind recessed pocket in the wall portion 502. Unlike the collar 100 discussed above, the cavity portion 504 does not extend completely through the wall portion 502 to form a hole. The cavity portion 504 is configured to mechanically engage a protrusion 604 that is attached to or otherwise fixed with respect to the bulb 600. The protrusion 604 extends into the cavity portion 504 preventing the rotation of the bulb 600 with respect to the collar 500.

As shown in FIG. 5, the collar 500 includes an opening 506 formed in the wall portion 502. The key 312 of the lighting fixture 300 protrudes through the opening 506 when the collar 500 is installed. As previously described, the opening 506 permits external access to the key 312 and is also configured to mechanically engage with the key to prevent rotation of the collar 500 with respect to the light fixture 300.

In some embodiments, the collar 500 may not have a lower portion, if, for example, the collar is used on a light fixture that does not have a key. In this case, the LED bulb 600 and collar 500 may have one or more additional features that prevent the LED bulb 600 from being removed from the light fixture 300.

For example, as shown in FIGS. 5 and 7, the collar 500 also includes a lower portion 508 extending from one end of the wall portion 502. The lower portion 508 may prevent the LED bulb 600 and collar 600 from being removed from the lighting fixture 300. The lower portion 508 is structurally and functionally similar to the lower portion 108 of collar 100 discussed above with respect to FIGS. 1 and 4.

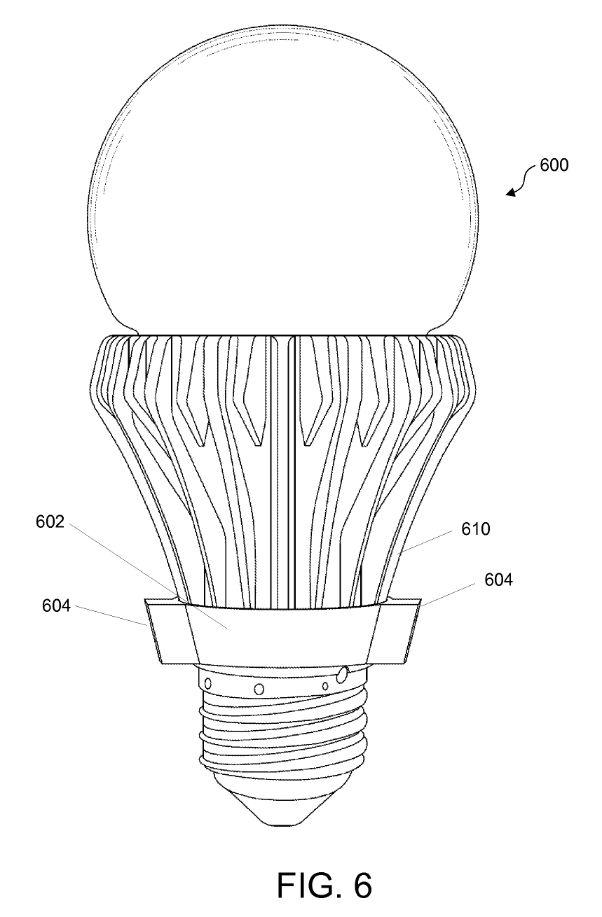

FIG. 6 depicts an exemplary LED bulb 600 that may be used with collar 500. LED bulb 600 includes two protrusions 604 that are formed as part of a ring 602. In this example, the protrusions 604 on LED bulb 600 are beveled at the outer edge to improve mechanical engagement with the recessed portion 504 of the collar 500. In particular, because the collar 500 is tapered near cavity portions 504, the beveled protrusions 604 maximize the engagement with the cavity portion 504 of the collar 500 by extending into the cavity portion 504 deeper than possible if the protrusions were square in profile shape.

FIG. 7 depicts a cross-sectional view of the collar 500 used to secure an LED bulb 600 with protrusions 604 to a socket housing 310 of a lighting fixture. As shown in FIG. 6, the protrusions 604 are formed as part of ring 602, which is integrated into the base 610 of the LED bulb 200. In this example, the ring 602 is configured to be integrated into the base 610 as part of the manufacturing process. In an alternative embodiment, the ring 602 could be configured for installation after manufacturing the LED bulb 600, by a purchaser or end-user of the LED bulb 600. In some embodiments, the ring 602 includes multiple grooves that are configured to mechanically engage with the fins of the base to prevent the ring 602 from rotating with respect to the LED bulb 600.

As shown in FIG. 7, the protrusions 604 extend radially from the central axis 650 of the LED bulb 600 and mechanically engage corresponding cavity portions 504 formed in the wall portion 502 of the collar 500. In this example, the protrusions 604 do not extend completely through the wall portion 502. The mechanical engagement between the protrusions 604 and the cavity portions 504 prevents the LED bulb 600 from rotating with respect to the collar 500. The collar 500 also includes a lower portion 508 configured to engage with the socket housing 310 to prevent the collar 500 and LED bulb 600 from being removed from the lighting fixture. The engagement between the lower porting 508 and the socket housing 310 is similar to that described above with respect to collar 100.

### 2. Anti-Theft Collar Installation and Removal

As previously mentioned, exemplary collars 100 and 500 are formed from two pieces for installation and removal. To install a two-piece collar, each piece of the collar is typically placed on either side of the base of a light bulb installed within a light fixture. The pieces of the collar are aligned with protrusions or nubs on the light bulb so that corresponding features on the collar (cavity portions or ribs) mechanically engage with the light bulb. Additionally, the pieces of the collar are aligned so that the opening in the wall portion of the collar aligns with a key on the light fixture. If the light fixture includes a key, the key protrudes through the opening when the collar is installed.

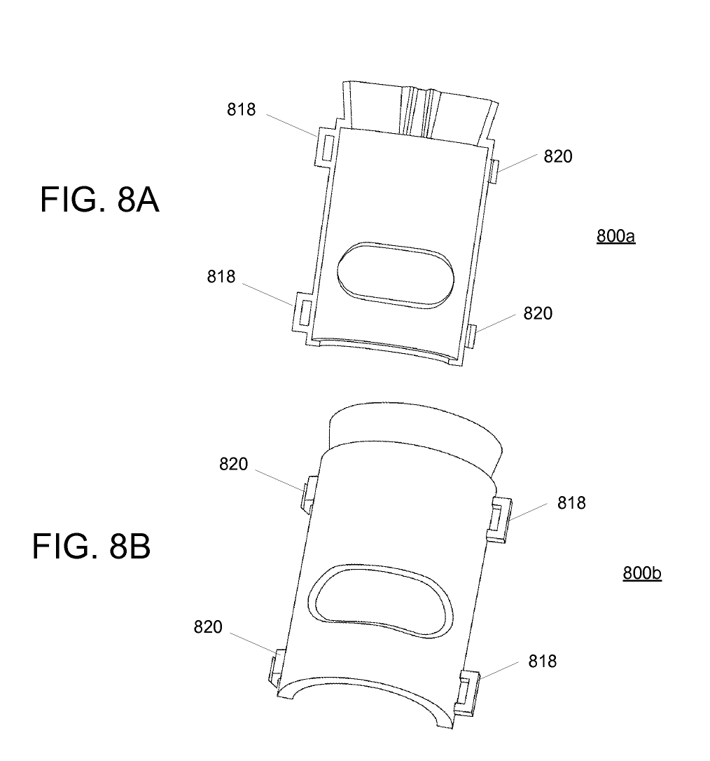

The two pieces of the collar are then pressed together around the base of the light bulb and the light fixture to abut the edges of the two pieces of the collar and engage the mechanical interlocks (described in more detail below with respect to FIGS. 8A-B and 9A-C). When installed in this manner, the collar encloses at least a portion of a socket housing of the light fixture and at least a portion of the base of the light bulb. The pieces of the collar may be symmetric or have identical geometry. In some cases, the pieces of the collar are not symmetric. Non-symmetric or non-identical geometry may further inhibit the removal of the collar by preventing disengagement of the mechanical interlocks by shifting of the pieces with respect to each other.

FIGS. 8A-B depict two pieces of exemplary collar 800a and 800 b having a mechanical interlock for joining the pieces. The following example is provided with respect to collar pieces 800a and 800b that can be joined to form a collar 800. However, the mechanical interlocks may be substantially similar for the other collar embodiments 100 and 500, discussed above.

In this example, each piece of the collar 800 includes two tabs 820 and two slots 818. The tabs 820 on one piece of the collar (800a or 800b) slide into corresponding slots 818 on the other mating piece of the collar (800b or 800a) to join and lock the pieces together to form the collar 800. The tabs 820 are configured such that they are easy to insert but difficult to disengage once inserted, thus serving as a theft deterrent. In this example, the tabs 820 include a beveled leading edge to facilitate insertion into a corresponding slot 818. The tabs 820 also include a catch barb that engages with the slot 818 when installed to prevent disassembly of the two pieces.

As an additional deterrent, in this example, separation of the two pieces of the collar requires disengagement of multiple tabs 820 at the same time. Simultaneous disengagement may be made more difficult if the two pieces do not have interlocks having exactly the same geometry. For example, the tabs may be slightly offset to prevent the two pieces from being disassembled by merely shifting the pieces.

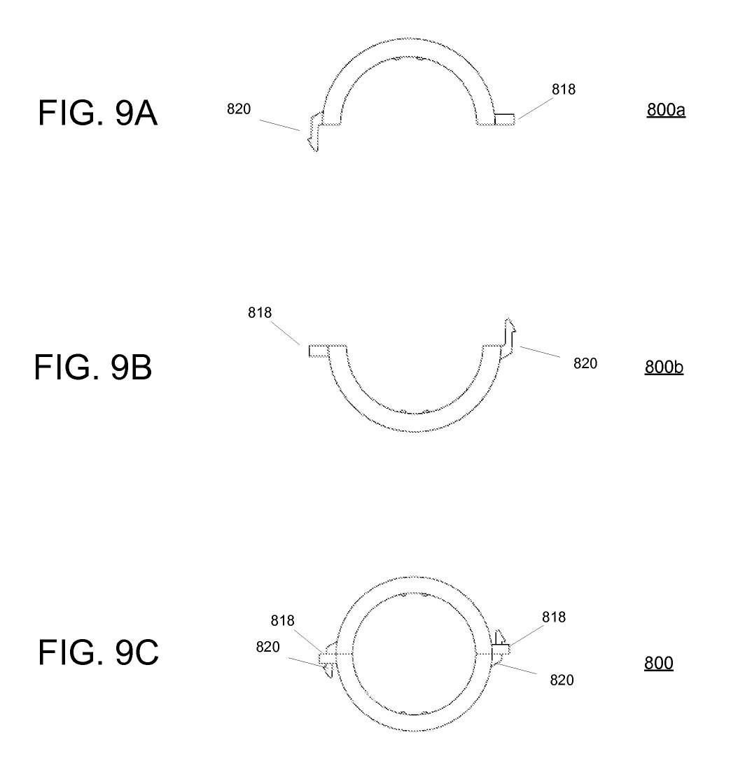

FIGS. 9A-B depict top views of two pieces of an anti-theft collar (800a and 800b) when the pieces are separated. FIG. 9C depicts a top view of the pieces (800a and 800b) when they are interlocked by sliding the tabs 820 into the slots 818 for form the complete collar 800. Other types of mechanical interlocks may be used to join the pieces of the collar 800. These may include, for example, a variety of fasteners, clasps, threaded connectors, or adhesives. In some embodiments, the mechanical interlock may comprise a flexible or inflexible band that encloses the collar. In some embodiments, the mechanical interlock may not be removable.

As discussed above, exemplary collars 100, 500, and 800 are designed to comprise two pieces to enable installation and removal. However, other collar designs that enable installation and removal are also possible. For example, a collar may comprise more than two pieces that can be locked together and detached from each other. The pieces of the collar may also hinge at one or more joints to enable them to pivot with respect to each other rather than detaching from each other completely. One or more pieces may also be connected to each other by a material or joint that provides for expansion between the sections, such as a flexible mesh or elastic.

The anti-theft collar may be fabricated from a variety of materials. These may include, for example, various forms of polycarbonates, metals, woods, or other materials that provide suitable strength and rigidity to prevent cracking or breaking of the collar by hand. The anti-theft collar may be fabricated using an injection molding, a machining, or another fabrication technique. The anti-theft collar may be fabricated from one type of material, or the collar may be fabricated from multiple materials. For example, the mechanical interlocks may be fabricated from a different material than the walls of the collar, and attached to the collar using an adhesive, fastener, or other bonding technique.

The examples above are intended to be illustrative rather than comprehensive. A person having skill in the art will recognize that there are many possible collar designs and materials that will achieve the desired result of preventing removal of a light bulb from a light fixture.

What is claimed is:

1. An anti-theft system for preventing removal of a light bulb when installed in a socket housing of a light fixture, the anti-theft system comprising:
a ring having a protrusion, wherein the ring is configured to be attached to the light bulb; and
an anti-theft collar configured to mechanically engage with the ring and the socket housing, the collar comprising:
a wall portion configured to enclose at least a portion of the light bulb and at least portion of the socket housing,
a cavity portion formed within the wall portion, the cavity portion configured to engage the protrusion of the ring to inhibit rotation of the light bulb with respect to the anti-theft collar when the anti-theft collar is installed; and
a lower portion extending from one end of the wall portion, the lower portion having an upper surface configured to engage with an opposing lower surface of the socket housing to inhibit motion of the anti-theft collar in a direction along a central axis of the light bulb.

2. The anti-theft system of claim 1, wherein the protrusion is formed from a rectangular protrusion that extends outward radially from the central axis of the light bulb when the ring is installed on the light bulb.

3. The anti-theft system of claim 1, the anti-theft collar further comprising:
an opening formed in the wall portion, the opening configured to at least partially encircle a key in the socket housing when the anti-theft collar is installed to inhibit rotation of the anti-theft collar with respect to the light fixture by mechanically engaging with the key.

4. The anti-theft system of claim 1, wherein the cavity portion is formed from an opening in the wall portion of the anti-theft collar.

5. The anti-theft system of claim 1, wherein the cavity portion is formed from a blind recess in the wall portion of the anti-theft collar.

6. The anti-theft system of claim 1, wherein the anti-theft collar is formed from two pieces that are configured to be mechanically joined by one or more mechanical interlocks.

7. The anti-theft system of claim 6, wherein the two pieces do not have identical geometry.

8. The anti-theft system of claim 6, wherein each mechanical interlock comprises:
a tab portion on a first of the two pieces; and
a slot portion on a second of the two pieces, wherein the tab portion and the slot portion are configured to interlock with each other.

9. The anti-theft system of claim 8, wherein the tab portion includes a beveled leading edge to facilitate installation and the tab portion includes a catch barb to inhibit removal of the anti-theft collar after installation.

10. The anti-theft system of claim 1, wherein the anti-theft collar is formed from more than two pieces.

11. The anti-theft system of claim 1, wherein the light bulb includes a base having a threaded portion for insertion into the socket housing, and wherein the ring is configured to be attached to the base of the light bulb above the threaded portion.

12. The anti-theft system of claim 1, wherein the ring is configured for installation on the base of the light bulb after the light bulb has been manufactured.

13. The anti-theft system of claim 1, wherein the light bulb is an LED bulb.

14. The anti-theft system of claim 1, wherein the light bulb is a compact fluorescent bulb.

15. An anti-theft collar for preventing removal of a light bulb when installed in a socket housing of a light fixture the light bulb having a protrusion, the collar comprising:
a wall portion configured to enclose at least a portion of the light bulb and at least portion of the socket housing,
a cavity portion formed within the wall portion, the cavity portion configured to engage the protrusion of the light bulb to inhibit rotation of the light bulb with respect to the anti-theft collar when the anti-theft collar is installed; and
a lower portion extending from one end of the wall portion, the lower portion having an upper surface configured to engage with an opposing lower surface of the socket housing to inhibit motion of the anti-theft collar in a direction along a central axis of the light bulb.

16. An anti-theft system for preventing removal of a light bulb installed in a socket housing of a light fixture, the anti-theft system comprising:
a ring having a protrusion, wherein the ring is configured to be attached to the light bulb; and
an anti-theft collar configured to mechanically engage with the ring and the socket housing, the collar comprising:
a wall portion configured to enclose a portion of the light bulb and a portion of the socket housing,
a cavity portion formed within the wall portion, the cavity portion configured to engage the protrusion of the light bulb to inhibit rotation of the light bulb with respect to the anti-theft collar when the anti-theft collar is installed; and
an opening formed in the wall portion, the opening configured to at least partially encircle a key of the light fixture when the anti-theft collar is installed to inhibit rotation of the anti-theft collar with respect to the light fixture by mechanically engaging with the key.

17. The anti-theft system of claim 16, wherein the protrusion is formed from a rectangular protrusion that extends outward radially from the central axis of the light bulb when the ring is installed on the light bulb.

18. The anti-theft system of claim 16, wherein the cavity portion is formed from an opening in the wall portion of the anti-theft collar.

19. The anti-theft system of claim 16, wherein the cavity portion is formed from a blind recess in the wall portion of the anti-theft collar.

20. The anti-theft system of claim 16, wherein the anti-theft collar is formed from two pieces that are configured to be mechanically joined by one or more mechanical interlocks, wherein each mechanical interlock comprises:
a tab portion on a first of the two pieces; and
a slot portion on a second of the two pieces, wherein the tab portion and the slot portion are configured to interlock with each other.

21. An anti-theft collar for preventing removal of a light bulb installed in a socket housing of a light fixture, the light bulb having a protrusion, the anti-theft collar comprising:
a wall portion configured to enclose a portion of the light bulb and a portion of the socket housing,
a cavity portion formed within the wall portion, the cavity portion configured to engage the protrusion of the light bulb to inhibit rotation of the light bulb with respect to the anti-theft collar when the anti-theft collar is installed; and
an opening formed in the wall portion, the opening configured to at least partially encircle a key of the light fixture when the collar is installed to inhibit rotation of the anti-theft collar with respect to the light fixture by mechanically engaging with the key.
